(19) United States
(12) Patent Application Publication
(10) Pub. No.: US 2026/0179120 A1
(43) Pub. Date: Jun. 25, 2026

(54) METHOD AND COMPUTER SYSTEM FOR DISPLAYING ADVERTISING CHANNEL INFORMATION AND ADVERTISING CONTENT ITEM ABOUT PRODUCT OR SERVICE BASED ON SEARCH KEYWORD

(71) Applicant: NAVER CORPORATION, Seongnam-si (KR)

(72) Inventors: Yunjee LEE, Seongnam-si (KR); Jinseok LIM, Seongnam-si (KR); Jae Min AHN, Seongnam-si (KR); Min Gyeom KIM, Seongnam-si (KR); Sungeun KIM, Seongnam-si (KR)

(21) Appl. No.: 19/264,005

(22) Filed: Jul. 9, 2025

(30) Foreign Application Priority Data
Dec. 24, 2024 (KR) 10 2024 0195808

(51) Int. Cl. G06Q 30/0251

(52) U.S. Cl. CPC G06Q 30/0256

(57) ABSTRACT

A method of displaying an advertising content item includes displaying, as search results for a search term received from a user, information on an advertising channel associated with the search term and at least one advertising content item that links to a detailed information page for a product or service being sold through the advertising channel.

### CROSS-REFERENCE TO RELATED APPLICATION(S)

This U.S. non-provisional application claims the benefit of priority under 35 U.S.C. § 119 to Korean Patent Application No. 10-2024-0195808 filed on Dec. 24, 2024, in the Korean Intellectual Property Office (KIPO), the entire contents of which are incorporated herein by reference.

### BACKGROUND OF THE INVENTION

### Field of Invention

One or more example embodiments of the following description of the present invention relate to a method and a system for providing advertisements related to a search term entered by a user, and more particularly, to a method and a system for displaying an advertising content item related to a product or service being sold through an advertising channel together with information on the advertising channel related to the entered search term.

### Description of Related Art

A user may enter a search term in an Internet environment and may acquire information related to the search term through a search engine. A search action by the user using this search term may be a clue to understanding the user's interest or intent, and may be utilized to provide a highly effective advertisement to the user.

A search results page including search results for the search term entered by the user generally includes an advertisement related to the search term entered by the user. The advertisement may relate to an advertising channel (e.g., website, Internet shopping mall, social networking service (SNS) platform, etc.) related to the search term entered by the user. This advertising channel (i.e., business (Biz) channel) may be registered to a platform by an advertiser and advertisements related to the advertising channel may be displayed on the search results page in response to a search action of the user using a relevant search term.

In addition to simply providing information on an advertising channel on a search results page, a method is required to provide additional information on a product or service being sold through the advertising channel, thereby providing a higher advertising effect to a user who conducts a search using a search term and, at the same time, improving advertiser satisfaction.

Korean Patent Registration No. 10-0481141 (registered on Mar. 25, 2005) describes a search term advertisement providing system and a search term advertisement providing method for extracting search listing in response to a predetermined search request.

### BRIEF SUMMARY OF THE INVENTION

One or more example embodiments of the present invention may provide a method of displaying, as search results for a search term received from a user, information on an advertising channel associated with the search term and at least one advertising content item that links to a detailed information page for a product or service being sold through the advertising channel, that is, displaying the advertising content item associated with the search term.

According to an aspect of the present invention, there is provided a method of displaying an advertising content item associated with a search term, performed by a computer system that is a user terminal, the method including receiving a search term from a user; and displaying, as search results for the search term, information on an advertising channel associated with the search term and at least one advertising content item that links to a detailed information page for a product or service being sold through the advertising channel.

The displaying may include displaying, as the information on the advertising channel, a link of the advertising channel and the advertising content item in an advertisement display area within a search results page that provides the search results for the search term.

The advertisement display area may be provided at the upper end on the search results page, below a search term input field.

The displaying may include displaying a plurality of advertising content items that link to a detailed information page for each of products or services being sold through the advertising channel within a carousel user interface (UI) to be distinguished from information on the advertising channel, and the carousel UI may be configured to sequentially display at least some of the plurality of advertising content items without leaving the search results page in response to a detection of an interaction from the user with the carousel UI.

The advertising content item may be configured to include at least two additional information items for the product or service being sold through the advertising channel such that different additional information items are included depending on a type of a vertical service associated with the advertising channel or a type of the product or service being sold through the advertising channel.

The at least two additional information items may include an image associated with the product or service being sold through the advertising channel, and at least one of price information on the product or service and review information on the product or service.

The displaying may include displaying the at least one advertising content item on the search results page and displaying a fewer number of advertising content items as the width of the search results page, the width of the advertisement display area, or the width of the user terminal becomes smaller.

As the fewer number of advertising content items are displayed on the search results page, the advertising content item may be configured to include more additional information items for the product or service being sold through the advertising channel.

The advertising content item may include an image associated with the product or service being sold through the advertising channel and selection history information on the product or service.

The displaying may include displaying an advertising content item including the selection history information above other advertising content items for other products or other services being sold through the advertising channel.

The advertising content item may be displayed in a form in which an image and price information associated with the product or service being sold through the advertising channel are synthesized.

The advertising channel is to advertise a service or product provided at a specific location, and the method of displaying the advertising content item may further include, in response to a selection on the advertising content item from the user, displaying the detailed information page that includes detailed information on the product or service or a detailed information page of the advertising channel.

The advertising channel is to advertise a service or product provided in a specific shopping mall, and the method of displaying the advertising content item may further include, in response to a selection on the advertising content item from the user, displaying the detailed information page that includes detailed information on the service or product within the specific shopping mall.

According to another aspect, there is provided a computer system that is a user terminal to display an advertising content item associated with a search term, the computer system including at least one processor configured to execute computer-readable instructions included in a memory, wherein the at least one processor is configured to receive a search term from a user, and to display, as search results for the search term, information on an advertising channel associated with the search term and at least one advertising content item that links to a detailed information page for a product or service being sold through the advertising channel.

According to some example embodiments, by providing additional information on a product or service being sold through a corresponding advertising channel in addition to simple general information on the advertising channel as advertisements provided on a search results page, it is possible to provide more effective advertisements to a user who conducts a search using a search term and, at the same time, improve advertiser satisfaction.

According to some example embodiments, by displaying an advertising content item that links to a detailed information page for a product or service being sold through an advertising channel on a search results page in an intuitive format that includes additional information items (image, price, review information, etc.) for the product or service, it is possible to improve the convenience of a user that interacts with an advertisement.

According to some example embodiments, by providing a plurality of advertising content items that links to a detailed information page for a product or service being sold through an advertising channel through a carousel user interface (UI), it is possible to effectively display the plurality of advertising content items on a search results page without compromising the visibility of search results provided through the search results page.

Further areas of applicability will become apparent from the description provided herein. The description and specific examples in this summary are intended for purposes of illustration only and are not intended to limit the scope of the present invention.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 illustrates a method of determining an advertising content item for a product or service to be displayed in association with information on an advertising channel in response to a search request using a search term, and displaying the determined advertising content item together with the information on the advertising channel according to one example embodiment;

FIG. 2 is a block diagram illustrating a computer system for determining an advertising content item and a computer system constituting a user terminal that displays the advertising content item according to one example embodiment;

FIG. 3 is a flowchart illustrating a method of determining an advertising content item for a product or service to be displayed in association with information on an advertising channel in response to a search request using a search term according to one example embodiment;

FIG. 4 is a flowchart illustrating a method of acquiring search results for a search term used to generate an advertising content item according to one example;

FIG. 5 is a flowchart illustrating a method of determining an advertising content item for a product or service based on a query intent indicated by a search term according to one example;

FIG. 6 is a flowchart illustrating a method of displaying, on a user terminal, an advertising content item for a product or service in association with information on an advertising channel in response to a search request using a search term according to one example embodiment;

FIGS. 7A to 7C and FIGS. 8A to 8C illustrate a method of displaying an advertisement including advertising content item(s) associated with a search term in an advertisement display area included in a search results page according to one example;

FIG. 9 illustrates a search results page that includes a search result display area and an advertisement display area according to one example;

FIGS. 10A and 10B illustrate a method of displaying advertising content item(s) on a search results page in association with an advertising channel related to a specific location according to one example;

FIG. 11 illustrates a method of landing a detailed information page for a corresponding product or service on a user terminal in response to a selection on an advertising content item for the product or service according to one example;

FIGS. 12A and 12B illustrate a method of landing a home screen of a detailed page of business corresponding to an advertising channel as a detailed page of the advertising channel in response to a selection on the advertising content item according to one example;

FIG. 13 illustrates a display element included in an advertising content item and a display condition thereof according to one example;

FIG. 14 illustrates a display element included in an advertising content item according to an advertising channel or a type of a product or service being sold through the advertising channel according to one example;

FIGS. 15 and 16 illustrate data extracted from search results to generate an advertising content item in conjunction with a vertical service search engine according to one example; and

FIGS. 17 and 18 illustrate a method of determining an advertising content item for a product or service to be displayed in association with information on an advertising channel in response to a search request using a search term, and displaying the determined advertising content item together with information on the advertising channel, in a relationship among an advertiser side, a vertical service search engine side, and an advertisement display side according to one example.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by the example embodiments.

### DETAILED DESCRIPTION OF THE INVENTION

One or more example embodiments of the present invention will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments of the present invention will be described with reference to the accompanying drawings.

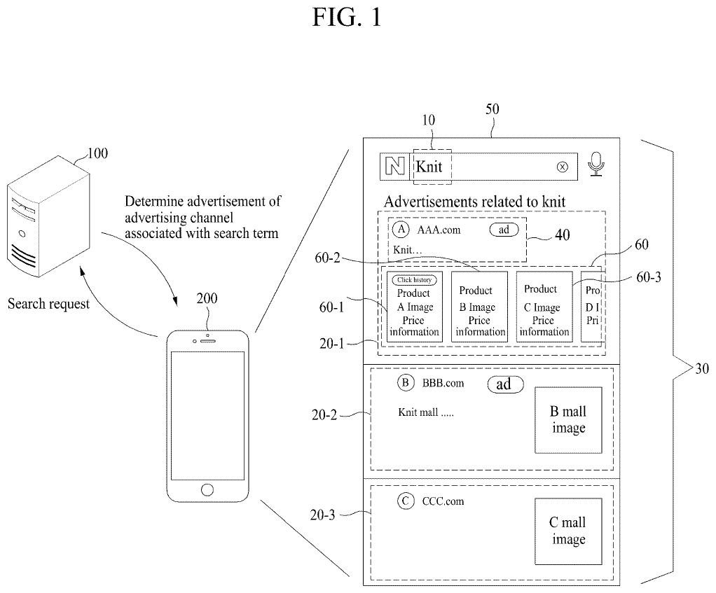

FIG. 1 illustrates a method of determining an advertising content item for a product or service to be displayed in association with information on an advertising channel in response to a search request using a search term, and displaying the determined advertising content item together with the information on the advertising channel according to one example embodiment.

A method of a computer system 100 that determines an advertisement of an advertising channel related to a search term 10 and displays the advertisement on a user terminal 200 in response to a search request using the search term 10 from the user terminal 200 is described with reference to FIG. 1.

The computer system 100 may be an advertising server or an advertising platform (or computer system that constitutes the advertising platform) configured to determine an advertisement to be displayed on the user terminal 200. The advertising server may be a system that manages and provides advertising content to be transmitted to the user terminal 200. This advertising server may determine an appropriate advertisement to be displayed on the user terminal 200 in response to a search request using a search term from a user (i.e., user terminal 200). The advertising platform (hereinafter, also referred to as platform) may be a relay system that interconnects the advertiser, a publisher, and the user, and the computer system 100 implementing the advertising platform may be a component that performs advertisement management, including registration of the advertisement.

The user terminal 200 refers to a computer system manipulated by the user, for example, a smartphone and a personal computer (PC), and may be configured such that the user may conduct a search request using the search term 10 and the advertisement determined by the computer system 100 may be displayed in response to the search request. In FIG. 1, a smartphone is illustrated as an example of the user terminal 200.

Describing an example embodiment with reference to FIG. 1, in response to the search term (e.g., “knit”) 10 from the user, the user terminal 200 may display advertisements 20-1 to 20-3 related to the search term 10 as search results for the search term 10.

The advertisements 20-1 to 20-3 may be displayed within a search results page 50. The search results page 50 may include a predetermined advertisement display area 30, and the advertisements 20-1 to 20-3 may be displayed in the advertisement display area 30. The advertisement display area 30 may be provided on one side of the search results page 50 and, for example, may be provided at the upper end on the search results page 50, below a search term input field.

The advertisement 20-1 displayed on the user terminal 200 may include information 40 on an advertising channel associated with the search term 10 and an advertising content item 60 for a product or service being sold through the advertising channel. One of advertising content items 60-1 to 60-3 included in the advertising content item(s) 60 may be configured to link to a detailed information page as a corresponding product or service among products or services being sold through the advertising channel in response to a selection from the user terminal 200.

Here, the advertising channel may be registered to the platform (or computer system 100) by the advertiser and may represent a channel that delivers information on a product or service to the user through an advertisement. The “advertising channel” may also be referred to as a “business channel (hereinafter, Biz channel).”

The advertising channel may be a website, a shopping mall, a brand store, a reservation service, or a place registered to the platform by the advertiser. This advertising channel may include a site for providing information on an online shopping mall, a blog, a café, and a specific location and a site for other third party services. For example, the advertiser may register a website or a shopping mall that the advertiser operates to the platform through the advertising channel. Through this, the advertiser may execute an advertisement that induces traffic to the advertising channel.

In an example embodiment, the advertisement 20-1 displayed on the user terminal 200 in response to the input of the search term 10 may include the information 40 on the advertising channel and the advertising content item 60 for products or services being sold through the advertising channel. The information 40 on the advertising channel may include a link (uniform resource locator (URL)) for linkage to the advertising channel (shopping mall “AAA. com” in the illustrated example) and text for explaining the advertising channel. Each or one of the advertising content items 60-1 to 60-3 in the advertising content item 60 may represent a product or service being sold through the advertising channel. For example, each or one of the advertising content items 60-1 to 60-3 may include image and price information of the product or service being sold through the advertising channel. Additionally, if a selection history, that is, a click history by the user for the product or service is present, the advertising content item 60-1 may further display the history.

The advertising content item 60 may be set to be displayed in association with the information 40 on the advertising channel by the advertiser that registers the advertising channel and accordingly, may be displayed in the advertisement display area 30. That is, the advertiser may register the advertising channel and then, may set whether to display the advertising content item 60 together in association with the information 40 on the advertising channel on the platform (or computer system 100). Display settings of the advertising content item 60 may also be referred to as “extended material registration” for a Biz channel that is the advertising channel. In addition to the information 40 on the advertising channel corresponding to basic information on the advertising channel, the advertiser may allow the advertising content item 60 including information on products or services being sold through the advertising channel to be displayed in the advertisement display area 30 together with the information 40 on the advertising channel as additional information through the extended material registration.

In the illustrated example, among the advertisements 20-1 to 20-3 related to the search term 10, the information 40 on the advertising channel and the advertising content item 60 are displayed through the advertisement 20-1, but the advertising content item 60 is not displayed through the advertisements 20-2 and 20-3. The advertisements 20-2 and 20-3 do not represent an extended material corresponding to the advertising content item 60, but an extended material corresponding to a “Powerlink image,” which may be a form of advertisement that adds a visual element (an image) to the existing Powerlink ads, in order to further increase user attention. A “Powerlink image” may represent a product or brand more intuitively than general text ads and may be an effective advertising method in categories where images are important, such as shopping, beauty, and travel. That is, the advertising content item 60 of the example embodiment may correspond to an extended material, for example, “shopping information” or “place information,” among extended materials that may be registered.

In an example embodiment, in providing an advertisement for an advertising channel on the search results page 50, a more effective advertisement may be provided to the user terminal 200 that conducts a search using the search term 10 by additionally displaying the advertising content item 60 that is information on products or services being sold through the advertising channel in addition to simple general information such as the advertisement 20-1, for example, the information 40 on the advertising channel.

Registrations of advertising channels by advertisers on the platform and settings for displaying an advertising content item for a product or service being sold through each advertising channel in association with information on each advertising channel (i.e., extended material registration for each advertising channel) may be managed through the computer system 100. If the search term 10 is entered, the computer system 100 may determine an advertising channel associated with the search term 10 and an advertising content item to be displayed in association with information on the advertising channel.

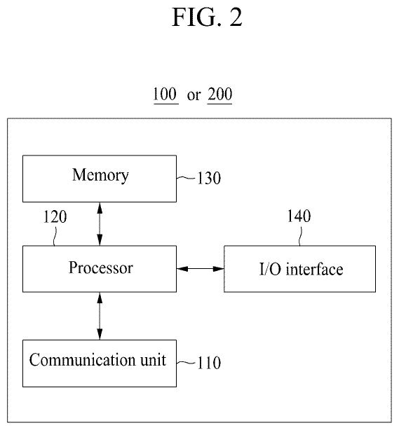

A method of determining an advertising content item, performed by the computer system 100, and a method of displaying the advertising content item, performed by the user terminal 200, are further described with reference to FIGS. 2 to 18 below.

FIG. 2 is a block diagram illustrating a computer system for determining an advertising content item and a computer system constituting a user terminal that displays the advertising content item according to at least one example embodiment.

The computer system 100 or 200 of FIG. 2 may represent the computer system 100 that constitutes the advertising server or platform (or computer system that constitutes platform) and the computer system 200 that constitute the user terminal 200, which are described above.

Initially, describing the structure of the computer system 100, the computer system 100 may include a memory 130, a processor 120, a communication unit 110, and an input/output (I/O) interface 140.

The memory 130 may include a permanent mass storage device, such as random access memory (RAM), read only memory (ROM), and disk drive, as computer-readable recording media. Here, ROM and the permanent mass storage device may be included as a separate permanent storage device, separate from the memory 130. Also, an operating system (OS) and at least one program code may be stored in the memory 130. Such software components may be loaded from computer-readable recording media separate from the memory 130. Such separate computer-readable recording media may include computer-readable recording media, such as floppy drive, disc, tape, DVD/CD-ROM drive, and memory card. In another example embodiment, software components may be loaded to the memory 130 through the communication unit 110 rather than the computer-readable recording media.

The processor 120 may be configured to process instructions of a computer program by performing basic arithmetic operations, logic operations, and I/O operations. The instructions may be provided from the memory 130 or the communication unit 110 to the processor 120. For example, the processor 120 may be configured to execute instructions received according to a program code loaded to the memory 130. The processor 120 may be configured to perform/execute operations for performing a method of determining an advertising content item of an example embodiment.

The communication unit 110 may be a configuration for the computer system 100 to communicate with another device (e.g., user terminal 200 or another server, another computer system or server that constitutes platform, etc.). That is, the communication unit 110 may be a hardware module, such as an antenna, a data bus, a network interface card, a network interface chip, and a networking interface port of the computer system 100 or a software module, such as a network device driver and a networking program, which are used to transmit/receive data and/or information to/from another device.

The communication scheme of the communication unit 110 is not limited and may also include a near field wireless communication scheme between devices as well as a communication scheme using a communication network (e.g., mobile communication network, wired Internet, wireless Internet, and broadcasting network) includable in a network used by the computer system 100. For example, the network may include at least one of networks that include a personal area network (PAN), a local area network (LAN), a campus area network (CAN), a metropolitan area network (MAN), a wide area network (WAN), a broadband network (BBN), and the Internet. Also, the network may include at least one of network topologies that include a bus network, a star network, a ring network, a mesh network, a star-bus network, and a tree or hierarchical network, but is not limited thereto.

The I/O interface 140 may be a device for interfacing with an input device, such as a keyboard, and a mouse and an output device, such as a display and a speaker.

The processor 120 may manage the components of the computer system 100, and as described above, may execute a program or an application for performing a method of determining an advertising content item of an example embodiment and may process operations required to execute the program or the application and to process data. The processor 120 may be at least one processor (central processing unit (CPU) or graphics processing unit (GPU)) of the computer system 100 or at least one core within the processor.

Also, in example embodiments, the computer system 100 and the processor 120 may include greater number of components than the illustrated components. The components included in the processor 120 may be a portion of the aforementioned processor 120 or a function implemented by the processor 120. That is, the components included in the processor 120 may be representations of different functions performed by the processor 120 in response to a control instruction according to a code of an OS or a code of at least one computer program.

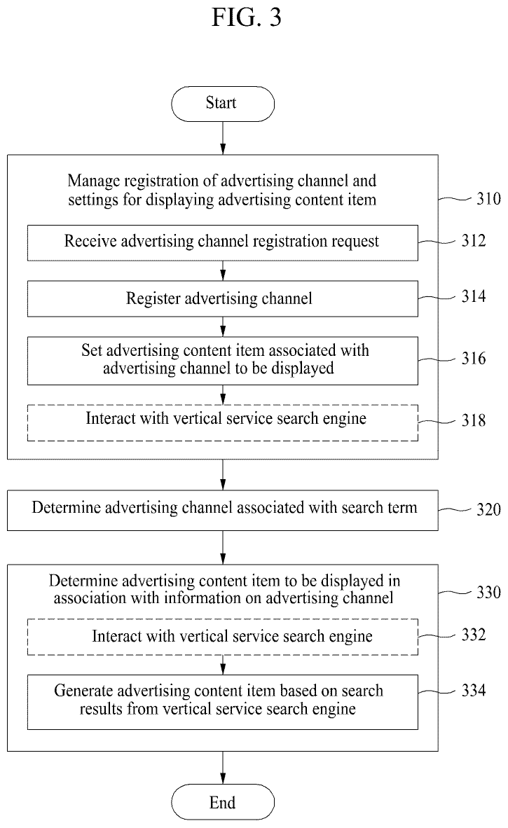

A method of determining an advertising content item of an example embodiment according to the operation of the processor 120 of the computer system 100 is further described with reference to FIGS. 3 to 18 below.

The computer system 200 that constitutes the user terminal 200 may include components similar to the computer system 100 and thus, repeated description is omitted. In the following, for convenience of description, example embodiments are described by naming the computer system 200 as the user terminal 200.

The user terminal 200 may be an electronic device configured to receive the search term 10 from the user, to request a search, to display search results through the search results page 50, and to display the advertisements 20-1 to 20-3 for the advertising channel determined by the computer system 100. The user terminal 200 may be a PC or a smartphone, or a device similar thereto capable of installing and executing an application or a program that performs the method of displaying an advertising content item of an example embodiment. For example, the user terminal 200 may be a PC, a notebook computer (laptop computer), a laptop computer, a tablet, an Internet of things (IoT) device, or a wearable computer.

Similar to the computer system 100, the user terminal 200 may include the communication unit 110, the memory 130, the processor 120, an interface, and the I/O interface 140 as components. Repeated description related thereto is omitted. Also, the I/O interface 140 of the user terminal 200 may include a display as a component for displaying the search results page 50 including the advertisements 20-1 to 20-3 under the control of the processor 120. The display may be a component in which an input function and an output function are integrated into one, such as a touchscreen.

The computer system 100 and the user terminal 200 may include more components than the illustrated components. For example, the user terminal 200 may be configured to include at least a portion of I/O devices connected to the aforementioned I/O interface 140, or may further include other components, such as a transceiver, a global positioning system (GPS) module, a camera, various types of sensors, and a database. In detail, for example, when the user terminal 200 is implemented in a form of a mobile device such as a smartphone, various components, such as a camera, an acceleration sensor or a gyro sensor, various types of physical buttons, a button using a touch panel, an I/O port, and a vibrator for vibration, which are generally included in the mobile device, may be implemented to be further included in the user terminal 200.

Description related to technical features made above with reference to FIG. 1 may be applied to FIG. 2 and repeated description is omitted.

In the following detailed description, for convenience of description, the operation performed by the computer system 100, or the processor 120 or the components thereof may be explained as the operation performed by the computer system 100. Likewise, the operation performed by the user terminal 200, or the processor 120, or the components of the processor 200 may be explained as the operation performed by the user terminal 200

FIG. 3 is a flowchart illustrating a method of determining an advertising content item for a product or service to be displayed in association with information on an advertising channel in response to a search request using a search term according to at least one example embodiment.

A method of the computer system 100 that determines the advertisements 20-1 to 20-3 for advertising channels to be displayed on the user terminal 200 in response to a search request using the search term 10 from the user is further described with reference to FIG. 3.

In operation 310, the computer system 100 may manage registration of advertising channels by advertisers for a platform and settings for displaying an advertising content item for a product or service being sold through each of the registered advertising channels in association with information on each corresponding advertising channel. That is, the computer system 100 may be configured to manage registration of Biz channels by the advertisers and registration of extended materials for the registered Biz channels.

The computer system 100 may manage a process for registration of advertising channels by the advertisers and the advertising channels registered accordingly. The computer system 100 may provide a user interface for registration of an advertising channel as an environment for registration of the advertising channel by an advertiser.

In operation 312, the computer system 100 may receive a registration request of an advertising channel for the platform from an advertiser. In operation 314, the computer system 100 may register the advertising channel to the platform based on a link of the advertising channel to be registered that is input from the advertiser. The link of the advertising channel may include a URL that links to the advertising channel.

For example, the advertiser may select the type (e.g., one of website, shopping mall, content, phone number, location information, reservation service, place (location), TV service, and brand store) of an advertising channel that an advertiser desires to register through the user interface, and may register the advertising channel on the platform by entering or selecting a name of the advertising channel that the advertiser desires to register and a link (URL) of the advertising channel. Registration of the advertising channel may additionally require authentication of the advertiser for the computer system 100. After this authentication is completed, the advertising channel may be registered by the advertiser. When registering the advertising channel, a list of advertising channel(s) provided by the platform that the advertiser may register or links of the advertising channel(s) may be displayed through the user interface, and the advertiser may complete registration by selecting an advertising channel to register from the list.

In operation 316, as the link of the advertising channel is input from the advertiser that registers the advertising channel, the computer system 100 may set an advertising content item for a product or service being sold through the registered advertising channel to be displayed in association with information on the advertising channel.

The computer system 100 may manage settings regarding whether to display an advertising content item by the advertiser that registers the advertising channel. That is, the computer system 100 may manage registration of “extended material” that is information to be additionally displayed with information on the advertising channel. The computer system 100 may provide a user interface for setting the advertising content item as a setting environment for the advertising content item.

The advertiser may set the advertising content item to be displayed as the extended material for the advertising channel registered by the advertiser. Therefore, referring to FIG. 1, the advertising content item 60 for the product or service being sold through the advertising channel may be displayed on the user terminal 200 that receives the advertisement 20-1 for the advertising channel, together with the information 40 on the advertising channel.

Through the user interface, the advertiser may input or select a link to the advertising channel registered by the advertiser, thereby setting the advertising content item for the product or service being sold through the registered advertising channel to be displayed in association with information on the advertising channel. The advertising content item 60 shown in FIG. 1 may be an extended material corresponding to “shopping information” as an extended material that is registered by the advertiser for the advertising channel, and the advertiser may select “shopping information” through the user interface and then input or select the link to the advertising channel, such that the advertising content item 60 may be displayed through the advertisement 20-1.

Registration of the extended material for the advertising channel (i.e., display settings of advertising content item) may be performed on an advertising group basis. For example, a single extended material may be registered per advertising group (e.g., only one extended material corresponding to the aforementioned shopping information or place information is possible per advertising group). That is, only one advertising content item may be set to be displayed per advertising group. Here, the advertising group may be a unit for identifying a subject to be advertised. The advertising groups may be classified by category of the product or service, campaign, or advertising target. For example, assuming campaign “fall sale promotion,” the advertising groups may be classified into advertising group 1 (“women's fashion” (targeting women in their 20s)), advertising group 2 (“men's fashion” (targeting men in their 30s)), and advertising group 3 (“children's fashion” (targeting moms/dads)).

In an example embodiment, for example, as shown in FIG. 1, to expose the advertising content item 60 through the advertisement 20-1, the advertiser is only required to input a link to the advertising channel, and is not required to directly input or select information on each product or service being sold through the advertising channel (i.e., a link to a detailed information page of each product or service, detailed information on each product or service, etc.). This allows the advertiser to easily include an advertising content item in an advertisement displayed in relation to the advertising channel registered by the advertiser.

Hereinafter, for convenience of description, the example embodiment is described by naming an advertising channel determined to be associated with the search term 10 among the registered advertising channels as a first advertising channel. The first advertising channel may represent at least one advertising channel among the advertising channels registered on the platform by advertisers. For example, in FIG. 1, the advertising channel displayed within the advertisement 20-1 displayed in response to search using the search term 10 may be the first advertising channel.

Also, for convenience of description, the example embodiment is described by naming an advertising content item for a product or service associated with the search term 10 as a first advertising content item. For example, the advertising content item 60 displayed with the information 40 on the first advertising channel, included in the advertisement 20-1 shown in FIG. 1 may be the first advertising content item.

In operation 320, the computer system 100 may determine the first advertising channel associated with the search term 10 entered by the user among the advertising channels registered on the platform. Here, the advertising content item 60 for the product or service being sold through the first advertising channel may be set to be displayed in association with the information 40 on the first advertising channel.

In operation 330, the computer system 100 may determine the first advertising content item for the product or service associated with the search term 10 among products or services being sold through the first advertising channel to be displayed in association with the information 40 on the first advertising channel. As such, the computer system 100 may determine the advertising content item 60 associated with the search term 10. As shown in FIG. 1, the computer system 100 may determine the first advertising content item 60 to be displayed together with the information 40 on the first advertising channel including the link to the first advertising channel on the search results page 50 for the search term 10.

The computer system 100 may determine at least one first advertising channel among the advertising channels registered based on a correlation with the search term 10, and may determine the product or service being sold through the first advertising channel based on the correlation with the search term 10. Therefore, the computer system 100 may determine the first advertising content item 60 for the determined product or service. Determining the first advertising content item 60 to be displayed through the advertisement 20-1 in operation 330 may include generating the first advertising content item 60. That is, the computer system 100 may generate the first advertising content item 60 based on information on the determined product or service.

Also, advertisements for a plurality of first advertising channels may be displayed on the search results page 50 for the search term 10, and each advertisement may include the first advertising content item 60 for a product or service being sold through each of the first advertising channels.

In the following, a method of the computer system 100 that determines the first advertising content item 60 for a product or service associated with the search term 10 in conjunction with a search engine is further described.

The computer system 100 may interact with a search engine to generate the first advertising content item 60 by determining the first advertising content item 60, that is, by determining the product or service being sold through the first advertising channel based on the correlation with the search term 10. This search engine may be a vertical service search engine

A vertical service may represent a specialized service focused on a specific field or industry. For example, the vertical service may represent a platform specialized in a specific category, such as travel, finance, healthcare, and shopping. The vertical service search engine may represent a search engine that provides search results limited to a specific topic or field, that is, limited to a specific vertical service. For example, the vertical service search engine may be a search engine specialized in searching for shopping product, real estimate information, and location (place) information.

In an example embodiment, the first advertising content item 60 may be generated from the search results from the vertical service search engine associated with the first advertising channel of the search term 10. That is, the first advertising content item 60 may be generated from the search results using the search term 10 from the vertical service search engine for a vertical service to which the first advertising channel belongs.

Each or one of the first advertising content items 60-1 to 60-3 included in the first advertising content item 60 may be generated in a form in which, for example, an image of the product or service and price of the product or service are synthesized as additional information related to the product or service. That is, the search results from the vertical service search engine may include the image and price as information on the product or service being sold through the first advertising channel, and each or one of the first advertising content items 60-1 to 60-3 included in the first advertising content item 60 may be generated in such a manner that the image and the price included in the search results are synthesized. The image of the product or service of each or one of the first advertising content items 60-1 to 60-3 may be a thumbnail image.

The search results from the vertical service search engine used to generate the first advertising content item 60 may correspond to the search results for the vertical service search engine in which the search term 10 is limited based on an ID of the first advertising channel such that only a product or service being sold through the first advertising channel is retrieved from the vertical service search engine. That is, the search results from the vertical service search engine used to generate the first advertising content item 60 may be the search results limited to the first advertising channel.

For example, the computer system 100 may call the search results limited to the product or service being sold through the first advertising channel in conjunction with the vertical service search engine (e.g., shopping specialized application search (SAS)) associated with the first advertising channel, and may generate the first advertising content item 60 using the search results. That is, to determine the first advertising content item 60, the computer system 100 may allow only the product or service within the first advertising channel related to the search term 10 to be retrieved by limiting the search term 10 to the first advertising channel (ID of first advertising channel) that registers the extended material. The search results may include a predetermined number (e.g., 8) of products or services, and one of the first advertising content items 60-1 to 60-3 including additional information on a corresponding product or service may be generated.

In operation 332, the computer system 100 may interact with the vertical service search engine when determining the first advertising content item 60 to be displayed on the search results page 50. For example, when the search term 10 is input and the search request is made, the computer system 100 may interact with the vertical service search engine in real time. The computer system 100 may acquire the search results including information on the product or service being sold through the first advertising channel associated with the search term 10 from the vertical service search engine in conjunction with the vertical service search engine, and may generate the first advertising content item 60 based on the search results. In response to the search request using the search term 10, the computer system 100 may interact with the vertical service search engine in real time to determine the first advertising content item 60 and accordingly, the first advertising content item 60 may include the latest information on the product or service being sold through the first advertising channel. Real-time interaction with the above vertical service search engine may be performed when the first advertising channel is, for example, an advertising channel that sells products, such as a shopping mall.

Depending on example embodiment, in operation 318, when setting the first advertising content item 60 for the product or service being sold through the first advertising channel to be displayed in association with the information 40 on the first advertising channel (i.e., when registering extended material for first advertising channel), the computer system 100 may interact with the vertical service search engine. The computer system 100 may acquire and store information on the product or service being sold through the first advertising channel as the search results, in conjunction with this vertical service search engine.

When determining the first advertising content item 60 in operation 330, the computer system 100 may generate the first advertising content item 60 based on this stored information. That is, the computer system 100 may interact with the vertical service search engine associated with the first advertising channel in advance at a point in time at which the extended material for the first advertising channel is registered, not at a point in time at which the search request using the search term 10 is made, and information on the product or service acquired in advance from the vertical service search engine may be used to generate the first advertising content item 60 in response to the search request using the search term 10. Non-real-time interaction with the above vertical service search engine may be performed when the first advertising channel is, for example, an advertising channel for advertising a service or a product provided at a specific location (place). Here, the vertical service search engine may be, for example, a vertical service search engine for an accommodation information providing service or a local information providing service.

Acquiring and storing information from the above vertical service search engine may be performed periodically, that is, at regular intervals. That is, information on the product or service being sold through the first advertising channel may be periodically acquired and stored in conjunction with the vertical service search engine. Accordingly, information on the product or service included in the resulting first advertising content item 60 may be periodically updated.

As described above, an interaction point in time with the vertical service search engine to determine the first advertising content item 60 may be different depending on the type of the first advertising channel.

Describing example embodiments with reference again to operation 334, the search results from the vertical service search engine used to determine the first advertising content item 60 may include a plurality of fields, and each of the plurality of fields may include information on the product or service being sold through the first advertising channel, The first advertising content item 60 may be generated to include information on at least one field extracted from among the plurality of fields. For example, the computer system 100 may generate the first advertising content item 60 by synthesizing selection history information on the product or service associated with the search term 10 and additional information (image and price information) on the product or service associated with the search term 10. Through this, the first advertising content item 60-1 including the selection history information (i.e., click history information) may be generated. The computer system 100 may refer to an API (e.g., recently viewed product API) to access a database that stores recently viewed product information, and accordingly may acquire the selection history information and generate the first advertising content item 60-1 that includes the selection history information. This selection history information may be synthesized into the first advertising content item 60-1 as an image that includes text, for example, “clicked N days ago” (e.g., N is 1 to 14). This allows the product or service with a predetermined number of, for example, up to 50, selection histories to be highlighted and displayed through an advertising content item.

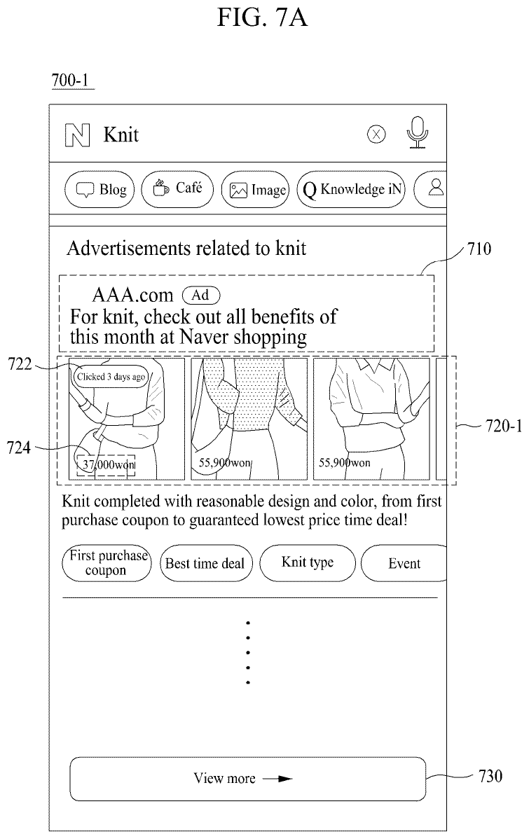

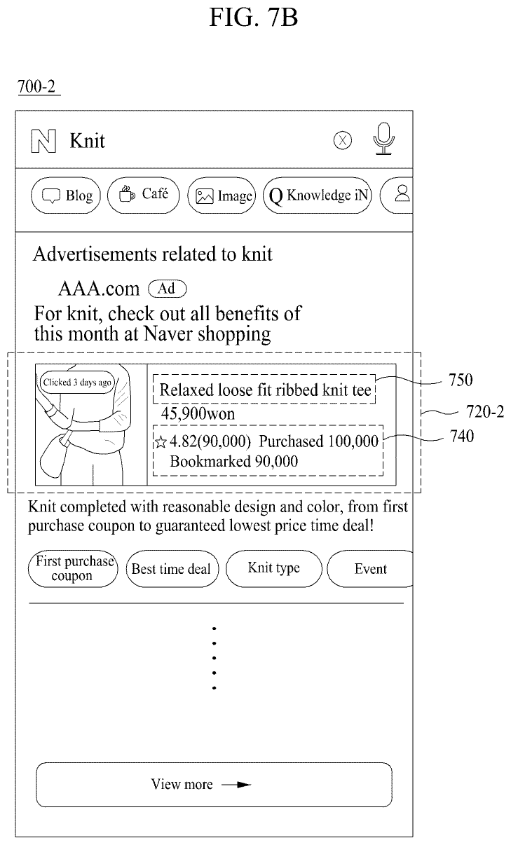

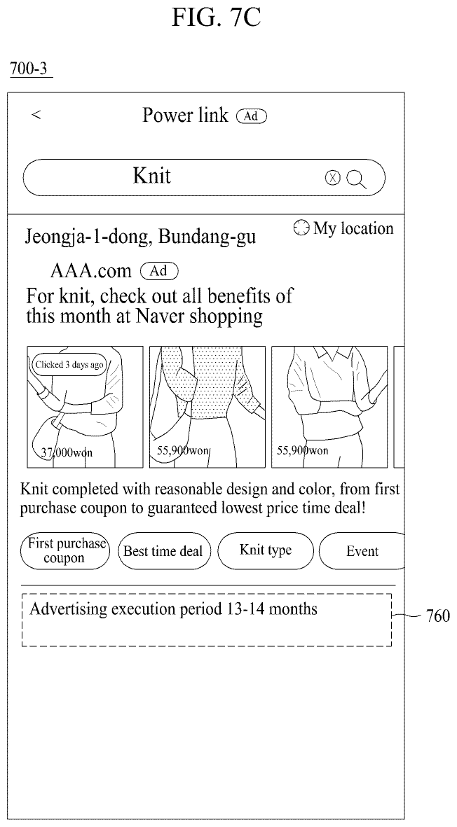

Also, the computer system 100 may extract information of different field(s) and may generate each first advertising content item based on at least one of a category of the product or service associated with the search term 10; a category of the first advertising channel; and the number of first advertising content items to be displayed with the first advertising channel. Generation of the first advertising content item 60 and detailed information included in the first advertising content item 60 will be further described with reference to FIGS. 7 to 16 below.

When determining the first advertising content item 60 in operation 330, the computer system 100 may determine one of the first advertising content items 60-1 to 60-3 respectively for a predetermined products or services having a high correlation (or relevance) with the search term 10 among the plurality of products or services being sold through the first advertising channel, in order to be displayed in association with the information 40 on the first advertising channel.

Here, the computer system 100 may display each of the first advertising content items 60-1 to 60-3 in order of high correlation with the search term 10 through the advertisement 20-1. However, the computer system 100 may determine a first advertising content item for a product or service having selection history by the user (i.e., user terminal 200) that enters the search term 10 among the predetermined number of products or services to be displayed at the upper end on the search results page 50 for the search term 10, that is, the advertisement 20-1, together with the information 40 on the first advertising channel. In the example of FIG. 1, the first advertising content item 60-1 may be associated with a product having the top relevance with the search term 10 and accordingly, may be displayed at the top in the advertisement 20-1 or may be displayed at the top in the advertisement 20-1 due to the presence of selection history, although the relevance with the search term 10 is the same or lower compared to other products. Alternatively, the rating for each product or service or the sales volume of each product or service may also be used as the basis for the display order of each of the first advertising content items 60-1 to 60-3.

As described above, in an example embodiment, when providing the advertisement 20-1 for the first advertising channel in the advertisement display area 30 within the search results page 50, the first advertising content item 60 including additional information on the product or service being sold through the first advertising channel may be displayed with the information 40 on the first advertising channel.

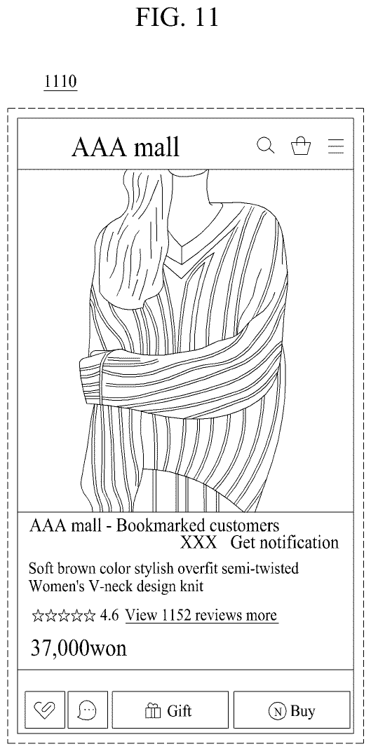

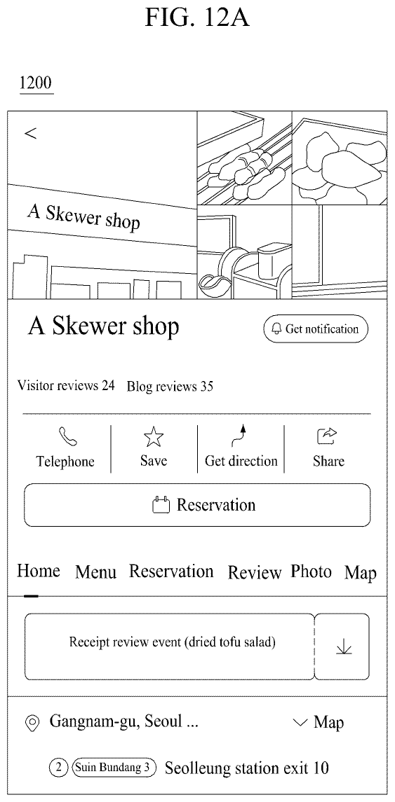

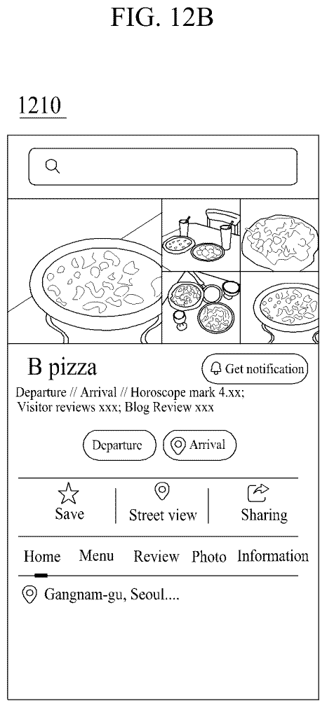

When each or one of the first advertising content items 60-1 to 60-3 is displayed in association with the first advertising channel and, here, is selected by the user (user terminal 200), the selected first advertising content item may be configured to link to a detailed information page for the product or service being sold through the first advertising channel associated with the selected first advertising content item. That is, one of the first advertising content items 60-1 to 60-3 may include a link to the detailed information page. The detailed information page that lands (i.e., is displayed) on the user terminal 200 in response to a selection on one of the first advertising content items 60-1 to 60-3 is further described with reference to FIGS. 11 and 12 below.

Description related to technical features made above with reference to FIGS. 1 and 2 may be applied to FIG. 3 and thus, repeated description is omitted.

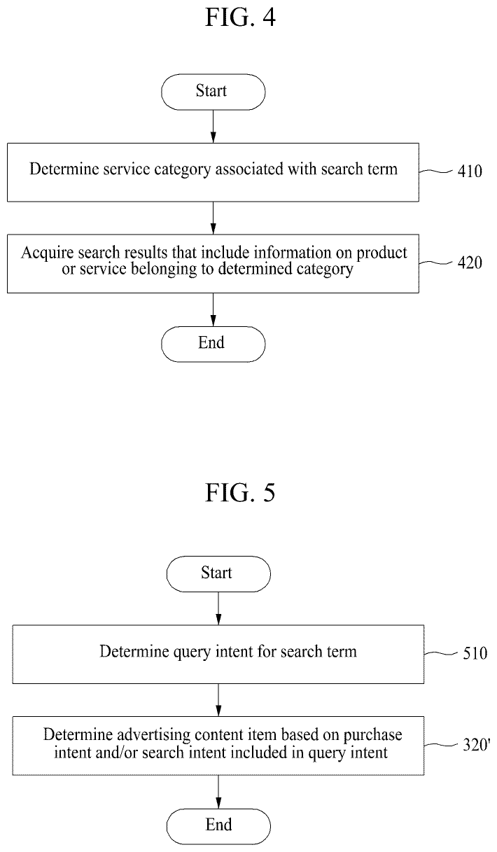

FIG. 4 is a flowchart illustrating a method of acquiring search results for a search term used to generate an advertising content item according to one example.

In operation 410, the computer system 100 may determine a category of a product or service associated with the search term 10 entered by the user.

In operation 420, the computer system 100 may acquire search results that include information on the product or service belonging to the determined category among products or services being sold through the first advertising channel. For example, as the computer system 100 interacts with the vertical service search engine in operation 332 described above, the computer system 100 may acquire the search results that include the information on the product or service belonging to the determined category as information for generating the first advertising content item 60.

Through operations 410 and 420, the first advertising content item 60 may include additional information on a product or service of a first advertising channel belonging to a category with higher or highest relevance to the search term 10.

For example, the computer system 100 may call, from the vertical service search engine, only products belonging to a category of which category correlation score (e.g., category mapping probability (CMP)) with the search term 10 is greater than or equal to a reference value. Here, the CMP may be a score that provides the category mapping probability for all search terms (or keywords) entered by the user, based on click share. The CMP may have a value between 0.0 and 1.0. In an example embodiment, if the search term 10, such as “electric bicycle,” is entered, categories with correlation (or CMP) greater than or equal to the reference value may be determined as “sports/leisure” and “bicycle,” and only products registered to the corresponding categories may be called from the vertical service search engine and displayed using an extended material (i.e., advertising content item).

The extended material in the example embodiment described with reference to FIG. 4 may be an extended material corresponding to the aforementioned shopping information.

Description related to technical features made above with reference to FIGS. 1 to 3 may be applied to FIG. 4 and thus, repeated description is omitted.

FIG. 5 is a flowchart illustrating a method of determining an advertising content item for a product or service based on a query intent indicated by a search term according to one example.

In operation 510, the computer system 100 may determine the query intent of the search term 10 for the search term 10 entered by the user.

In determining the first advertising content 60 as in operation 320, when the query intent of the search term 10 represents at least one of i) at least a predetermined level of purchase intent for the product or service and ii) at least a predetermined level of search intent to browse an advertising channel or a website, the computer system 100 may determine the first advertising content item 60 to be displayed in association with the information 40 on the first advertising channel.

The computer system 100 may include a query intent analyzer or access the query intent analyzer to determine the query intent of the search term 10. The query intent analyzer may be a tool that identifies the input query or the intent of the search term 10 and translates the same into a system processible form, for example, an artificial intelligence (AI)-based tool. The query intent analyzer may be, for example, a Bifrost query intent analyzer. The computer system 100 may quantify (score) the query intent of the search term 10 using the query intent analyzer to determine whether the search term 10 indicates i) at least a predetermined level of purchase intent for the product or service and/or ii) at least a predetermined level of search intent to browse the advertising channel or the website. The purchase intent may represent the user's desire to purchase the product or service, and the search intent may represent the user's desire to browse products on a website or explore various websites. If the purchase intent of i) or the search intent of ii) is greater than or equal to the reference value, the computer system 100 may determine the first advertising content item 60 to be displayed in association with the information 40 on the first advertising channel. That is, if the purchase intent of i) and the search intent of ii) are less than the reference value, the first advertising content item 60 may not be displayed in the advertisement display area 30. Therefore, in an example embodiment, only when the search term 10 or the query entered by the user has at least a predetermined level of search intent or purchase intent, the computer system 100 may allow the first advertising content item 60 to be displayed through the advertisement 20-1.

The search intent or the purchase intent may be determined based on, for example, a libero value of a Bifrost query intent analyzer. The libero value of the search term 10 may be a value within the appropriate range that numerically represents the purchase intent and the search intent.

In an example embodiment, the first advertising content item 60 may be selectively displayed through the advertisement 20-1 to not interfere with a search action of the user according to the identified intent of the search term 10.

Description related to technical features made above with reference to FIGS. 1 to 4 may be applied to FIG. 5 and thus, repeated description is omitted.

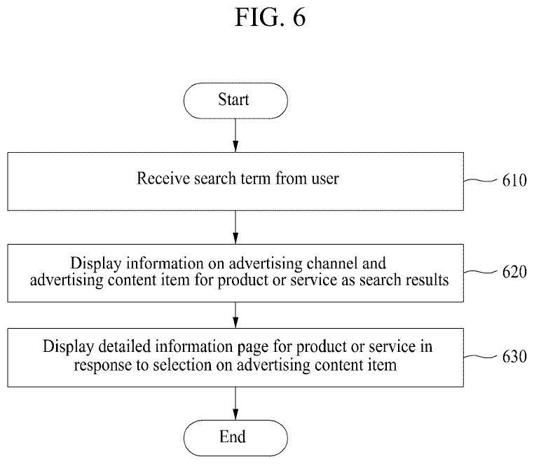

FIG. 6 is a flowchart illustrating a method of displaying, on a user terminal, an advertising content item for a product or service in association with information on an advertising channel in response to a search request using a search term according to at least one example embodiment.

A method of displaying an advertising content item (i.e., first advertising content item 60) associated with the search term 10 of an example embodiment is further described from perspective of the user terminal 200 with reference to FIG. 6.

In operation 610, the user terminal 200 may receive the search term 10 from the user. The search term 10 may include a query for a search request to a search engine. The search term 10 may include text. However, depending on example embodiments, the search term 10 may be input through voice or may include an image. If the search term 10 is entered and the search request is made, the search request may be delivered to the search engine (general search engine). Also, the search request using this search term 10 may be delivered to the computer system 100, and accordingly, operations described above with reference to FIGS. 3 to 5 may be performed.

In operation 620, as search results for the search term 10, the user terminal 200 may display the information 40 on an advertising channel (i.e., the aforementioned first advertising channel) associated with the search term 10 and at least one advertising content item 60 (i.e., the aforementioned first advertising content item) that links to a detailed information page for a product or service being sold through the advertising channel. The user terminal 200 may display a link to the advertising channel as the information 40 on the (first) advertising channel and the (first) advertising content item 60 together in the advertisement display area 30 within the search results page 50 that provides the search results for the search term 10.

In operation 630, in response to a selection on one of the (first) advertising content items 60-1 to 60-3, the user terminal 200 may display a detailed information page of the associated product or service. That is, when the first advertising content items 60-1 to 60-3 are displayed in association with the first advertising channel and, in this state, one of them is selected by the user (user terminal 200), a detailed information page for a product or service associated with the one selected from among the first advertising content items 60-1 to 60-3 may land on the user terminal 200. That is, each or one of the advertising content items 60-1 to 60-3 included in the first advertising content item 60 may include a link to the detailed information page of the associated product or service. The detailed information page that lands on the user terminal 200 is further described with reference to FIGS. 11 and 12 below.

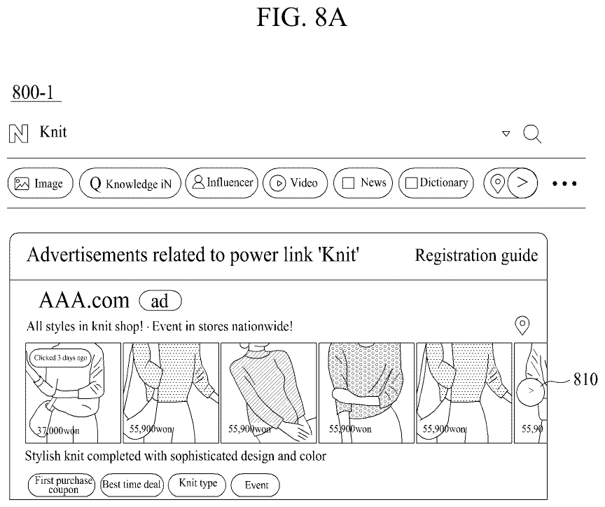

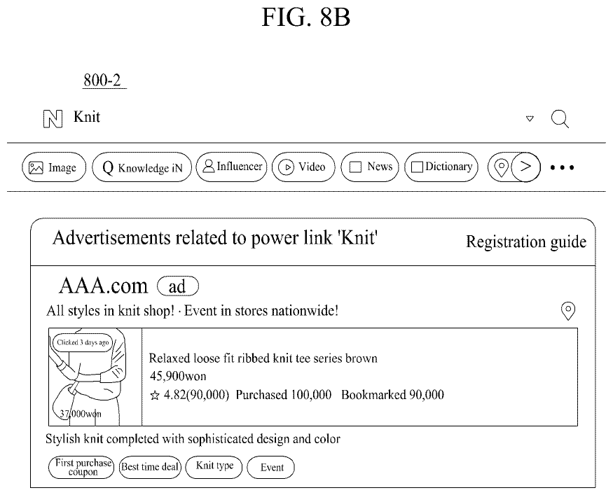

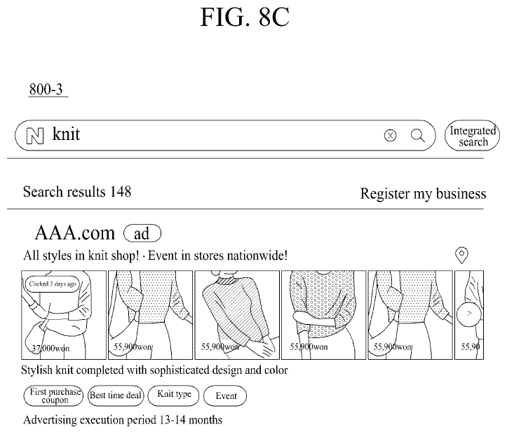

In the following, a method of displaying the advertising content item 60 in the advertisement display area 30 is further described with reference to FIGS. 7A-7C and 8A-8C.

In this regard, FIGS. 7A to 7C and FIGS. 8A to 8C illustrate a method of displaying an advertisement including advertising content item(s) associated with a search term in an advertisement display area included in a search results page according to one example.

Search results pages 700-1 and 700-2 illustrated in FIGS. 7A and 7B may be a portion of the search results page 50 of a mobile version, that is, displayed on the user terminal 200 that is a mobile terminal. As in FIG. 1, the advertisement display area 30 may be provided at the upper end on the search results page 700-1, 700-2, below a search term input field.

As shown in FIG. 7A, the user terminal 200 may display a plurality of advertising content items 720-1 that, respectively, link to detailed information pages for products or services being sold through an advertising channel to be displayed within a carousel user interface (UI) in order to be distinguished from information 710 on the advertising channel. A display location of each of the advertising content items 720-1 may be determined based on at least one of the correlation with the search term 10, the rating for each product or service, and the sale volume of each product or service within the carousel UI. Each of the advertising content items 720-1 may be determined by the computer system 100 through operation 330 described above.

The carousel UI may be configured to sequentially display at least some of the plurality of advertising content items 720-1 without leaving the search results page 700-1 as an interaction, for example, touch and swipe, is detected from the user for the carousel UI. That is, through interaction from the user for the carousel UI, the user may browse the advertising content items 720-1 included in the carousel UI.

Each of the advertising content items 720-1 may be in a form in which an image and price information 724 of a corresponding product (or service) are synthesized. As illustrated, the price information 724 may be displayed at the lower end of the image, and, to be clearly visually recognized within the image, for example, a lower area, in which the price information 724 is displayed in the image may be processed to be shadowed or translucent. Meanwhile, an advertising content item associated with a product having selection history (i.e., click history) by the user among the advertising content items 720-1 may further include selection history information 722. The advertising content item including the selection history information 722 may be provided to be displayed in higher order, that is, initially within the carousel UI compared to other content items.

That is, each advertising content item may be displayed in a form in which the image and the price information 724 associated with the product or service being sold through the advertising channel are synthesized, and at least one of the advertising content items 720-1 may include an image and the selection history information 722 for the product or service. Here, the user terminal 200 may display an advertising content item including the selection history information 724 in higher order than other advertising content item(s) for other products or other services being sold through the advertising channel.

FIG. 7B illustrates an example in which a single advertising content item 720-2 in addition to the information 710 on the advertising channel is displayed within the search results page 700-2. That is, FIG. 7B illustrates a case in which a single advertising content item 720-2 associated with a single product (or service) is displayed in terms of an advertisement for a single advertising channel.

The number of advertising content items in an advertisement for a single advertising channel may be, for example, one or plural depending on settings, or may be different depending on the width of the search results page 50, the width of the advertisement display area 30, or the width of a screen of the user terminal 200. The smaller the width of the user terminal 200, the fewer advertising content items the user terminal 200 may display.

However, as fewer advertising content items are displayed on the search results page 50, the displayed advertising content item may be configured to include more additional information items for a product or service being sold through a corresponding advertising channel. For example, compared to each of the advertising content items 720-1 shown in FIG. 7A, the advertising content item 720-2 shown in FIG. 7B may include additional information on an associated product or service. For example, the advertising content item 720-2 may further include description information 750 and review information 740 for an additional product or service in addition to price information and an image.

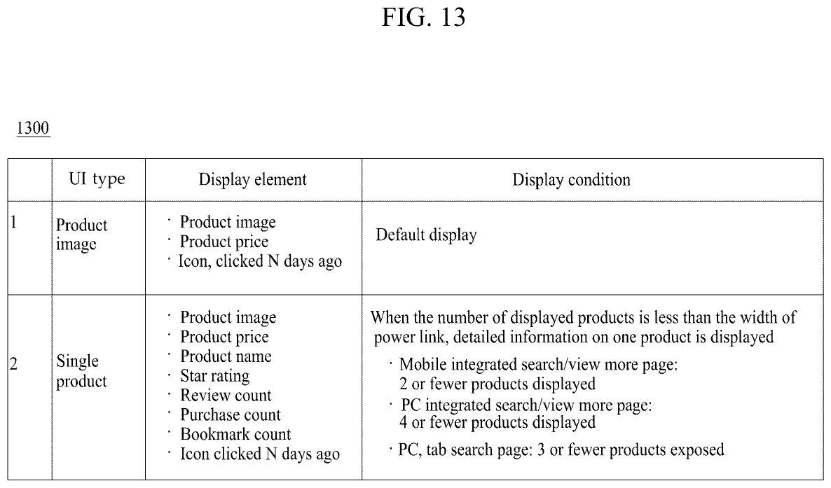

As described above, the advertising content item 720-1, 720-2 may be generated from data (i.e., search results) from the vertical service search engine, and the additional information item included in the advertising content item 720-1, 720-2 may represent information of each of a plurality of fields included in the search results from the vertical service search engine. That is, the advertising content item 720-1, 720-2 may be generated to include information on at least one field extracted from among the plurality of fields included in the search results from the vertical service search engine. For example, the computer system 100 may generate the first advertising content item 60 by synthesizing selection history information on the product or service associated with the search term 10 and additional information (image and price information) on the product or service associated with the search term 10. The computer system 100 may generate each advertising content item 720-1, 720-2 by extracting information of different field(s) based on at least one of a category of the product or service associated with the entered search term 10, a category of an advertising channel to be displayed, and the number of advertising content items to be displayed with the advertising channel. Generation of each advertising content item 720-1, 720-2 and detailed information included in each advertising content item 720-1, 720-2 are further described with reference to FIGS. 13 to 16 below.

FIG. 7C illustrates a screen 700-3 displayed on the user terminal 200 in response to a selection on a “view more” button 730 of FIG. 7A. Similar to that shown on the screen (i.e., page) 700-1 of FIG. 7A, advertisement(s) of the advertising channel may be displayed on the screen 700-3. Information 760 indicating a period during which a corresponding advertisement is executed in relation to an advertisement of the advertising channel may be further displayed on the screen 700-3. That is, the screen 700-3 may be a page that provides detailed information on advertisements (e.g., “Powerlink” advertisement) displayed in the advertising area 30. A similar screen may be displayed on the user terminal 200 even when a “view more” button of FIG. 7B is selected. “Powerlink” advertisement may be a keyword-based search advertisement that is displayed in text form at the top or the bottom of a search results page. For example, when a user searches for a specific keyword, Powerlink may be configured to display advertiser site links related to the keyword as advertisements at the top of the search results, so that they may attract the user's attention before the general search results.

FIGS. 8A to 8C show examples in which an advertisement of an advertising channel is displayed on a search results page 800-1 of a PC version. FIGS. 8A to 8C may correspond to FIGS. 7A to 7C, respectively. In FIG. 8A, a plurality of advertising content items may be displayed within a carousel UI in a similar manner as in FIG. 7A. Here, the number of advertising content items displayed on a single screen of the search results page 800-1 in FIG. 8A may be larger than that in FIG. 7A. That is, in a PC with a relatively larger screen or a search results page (advertising area of search results page) implemented as a PC version, a larger number of advertising content items may be displayed on a single screen.

As shown in FIG. 8A, the carousel UI may further include an interaction button 810, and the user may sequentially browse each of advertising content items included in the carousel UI by selecting the interaction button 810. Description made above with reference to FIGS. 7B and 7C may be similarly applied to a search results page 800-2 of FIG. 8B and a screen 800-3 of FIG. 8C, respectively, so repeated description is omitted.

As described above, according to example embodiments, advertising content item(s) determined according to the computer system 100 using the search term 10 may be variously displayed on a search results page of a PC version or a mobile version.

Description related to technical features made above with reference to FIGS. 1 to 5 may be applied to FIGS. 6 to 8 and thus, repeated description is omitted.

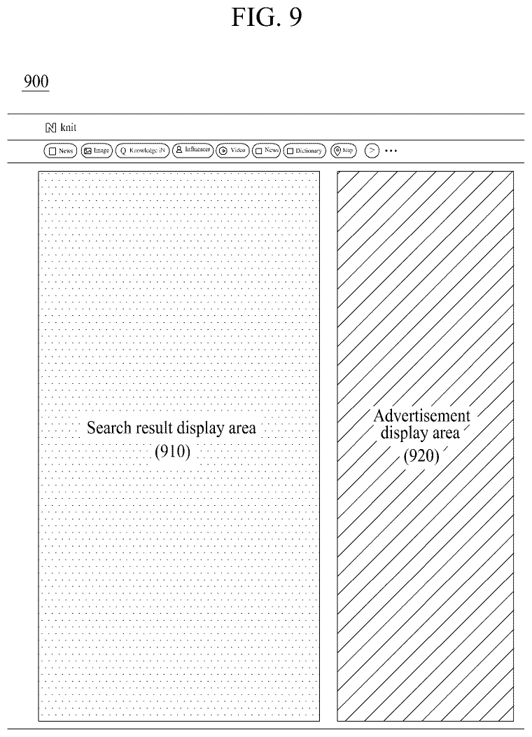

FIG. 9 illustrates a search results page that includes a search result display area and an advertisement display area according to one example.

FIG. 9 illustrates another example of a search results page 900 displayed on the user terminal 200 according to search using the search term 10. FIG. 9 illustrates the search results page 900 displayed on the user terminal 200 in response to a tab search, that is, a selection on a tab such as blog, café, Knowledge iN, or a tab such as illustrated view and image.

A search result display area 910 may be an area in which search results for the search term 10, that is, general search results are displayed according to the selected tab. As illustrated, an advertisement display area 920 may be provided on one side, for example, right of the search results page 900 and may be an area for displaying an advertisement (Powerlink advertisement) of an advertising channel described above. The information 40 on the advertising channel and the advertising content item 60 described above may be displayed in the advertisement display area 920. The search results page 900 may be a webpage implemented as a PC version.

Therefore, in an example embodiment, the user terminal 200 may appropriately display the information 40 on the advertising channel and the advertising content item 60 on the search results page 900 of the tab search as well as a search results page for displaying integrated search results.

Description related to technical features made above with reference to FIGS. 1 to 8 may be applied as is to FIG. 9 and thus, repeated description is omitted.

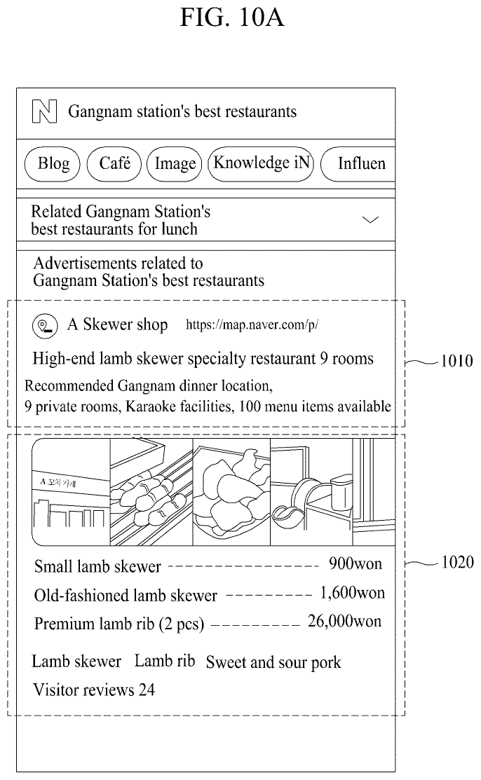

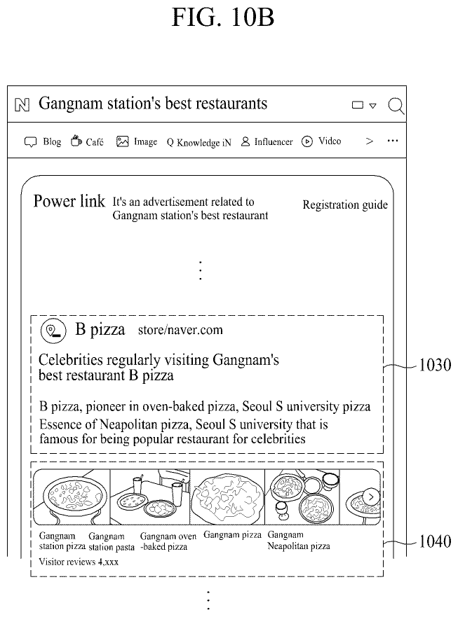

FIGS. 10A and 10B illustrate a method of displaying advertising content item(s) on a search results page in association with an advertising channel related to a specific location according to one example.

FIGS. 10A and 10B illustrate examples of a search results page displayed on the user terminal 200 in response to a search request by the search term 10 indicating a specific location (place). FIG. 10A illustrates a search results page of a mobile version, and FIG. 10B illustrates a search results page of a PC version. The computer system 100 may determine an advertising channel for advertising a service or product provided at a specific location associated with the search term 10, and may display an advertising content item 1020, 1040 for a product or service being sold through the advertising channel together with information 1010, 1030 on the advertising channel. In the illustrated example, the search term 10 is illustrated as “Gangnam station's best restaurants.” An advertisement for business corresponding to an advertising channel that is determined to be associated with the search term 10 may be displayed in an advertisement display area (e.g., a “Powerlink” advertisement display area) of the search results page. Depending on example embodiments, when the search results page is a search results page of a tab search, the advertisement display area may correspond to the advertisement display area 920 described above with reference to FIG. 9.

The advertising content item 1020, 1040 may be displayed on the search results page through a carousel UI. Each advertising content item included in the advertising content item 1020, 1040 may include an image of an associated product or service. This advertising content item 1020, 1040 may be displayed on the search results page, for example, in response to registration of an extended material corresponding to the aforementioned “place information.” Price information may not be displayed in the image of the advertising content item 1020, 1040. Instead, price information, review count, keyword, menu information, or at least one thereof may be displayed at the bottom of the image of the advertising content item 1020.

As can be seen by comparing FIGS. 7A-7C and 8A-8C and FIGS. 10A and 10B, the search results page 700-1, 800-1 corresponding to the advertising channel of the shopping mall type (category) and the advertising content item 720-1 included therein may be implemented to be different from the search results page corresponding to the advertising channel of the place type and the advertising content item 1020, 1040 included therein. That is, the advertising content item displayed together with information on the advertising channel may include a different additional information item according to the advertising channel or the type of the product or service handled by the advertising channel, and a form of the search results page may also vary.

Description related to technical features made above with reference to FIGS. 1 to 9 may be applied to FIGS. 10A and 10B and thus, repeated description is omitted.

FIG. 11 illustrates a method of landing (i.e., displaying) a detailed information page for a corresponding product or service on a user terminal in response to a selection on an advertising content item for the product or service according to an example, and FIGS. 12A and 12B illustrate a method of landing a home screen of a detailed page of business corresponding to an advertising channel as a detailed page of the advertising channel in response to a selection on the advertising content item.

FIG. 11 illustrates an example of a detailed information page 1110 that lands on the user terminal 200 in response to a selection on an advertising content item, in a case in which the advertising channel is an advertising channel for advertising a service or product provided from a specific shopping mall. For example, the detailed information page 1110 may land on the user terminal 200 when one of the advertising content items shown in FIG. 7A is selected. The detailed information page 1110 may include a detailed image of a thumbnail image included in the selected advertising content item, detailed information on price information included in the advertising content item, and review information on a product. The detailed information page 1110 may provide a purchase function for the corresponding product.

As described above, in an example embodiment, when an advertising content item is selected by the user from among advertisements of a specific shopping mall displayed on a search results page, a detailed information page including detailed information on the service or product may be displayed within the specific shopping mall. Therefore, the user may directly access the detailed information page of the product or service through the advertising content item and may immediately purchase the corresponding product or service without a need to go through the inconvenience of visiting the specific shopping mall and directly searching for the product or service.

FIGS. 12A and 12B illustrate examples of detailed information pages 1200 and 1210 that land on the user terminal 200 when an advertising content item is selected in a case in which an advertising channel relates to advertising a service or product provided at a specific location. For example, the detailed information page 1200 may be a page that lands on the user terminal 200 in response to a selection on one of the advertising content items shown in FIG. 10A. The detailed information page 1210 may be a page that lands on the user terminal 200 in response to a selection on one of the advertising content items shown in FIG. 10B. The detailed information page 1200, 1210 may be a home screen of a detailed page of business (aforementioned pasta restaurant) corresponding to the advertising channel as the detailed information page corresponding to the advertising channel. The detailed information page 1200, 1210 may include text giving information about the business, and may display information on a product or service (e.g., food menu) provided by the business. As described above, in an example embodiment, if the advertising content item is selected, a webpage such as a home screen may land on the user terminal 200 as the detailed information page 1200, 1210 associated with the advertising channel.

Similarly, the user may directly access the detailed information page of the product or service through the advertising content item and may directly purchase the product or service without the need to go through the inconvenience of visiting the advertising channel and directly searching for the product or service.

Description related to technical features made above with reference to FIGS. 1 to 10B may be applied to FIGS. 11, 12A, and 12B and thus, repeated description is omitted.

FIG. 13 illustrates a display element included in an advertising content item and a display condition thereof according to one example.

An advertising content item described through the present disclosure may include at least two additional information items for a product or service being sold through an advertising channel. Each additional information item may represent information of each of a plurality of fields included in search results from a vertical service search engine. The advertising content item may be configured to include different additional information items depending on the type of a vertical service associated with the advertising channel or the type of the product or service being sold through the advertising channel.

Here, the at least two additional information items included in the advertising content item may include at least one of an image (i.e., thumbnail image) associated with the product or service being sold through the advertising channel, price information of the product or service, and review information on the product or service.

Also, as fewer advertising content items are displayed on a search results page, each advertising content item may be configured to include more additional information items for the product or service being sold through the advertising channel.

As shown in a table 1300 of FIG. 13, a display element may represent an additional information item included in the advertising content item. A UI type being “product image” may represent configuring the advertising content item 720-1 as shown in FIG. 7A and the UI type being “single product” may represent configuring the advertising content item 720-2 as shown in FIG. 7B. As shown in FIG. 7A, a product image, a product price, and icon ‘clicked N days ago’ (i.e., selection history information) may be displayed in the advertising content item 720-1. In comparison thereto, the advertising content item 720-2 may include more detailed information on a single product or service. In this case, the display element may include, particularly, review information in more detail. When fewer advertising content items are displayed, the advertising content items may include more detailed information on the corresponding products or services.

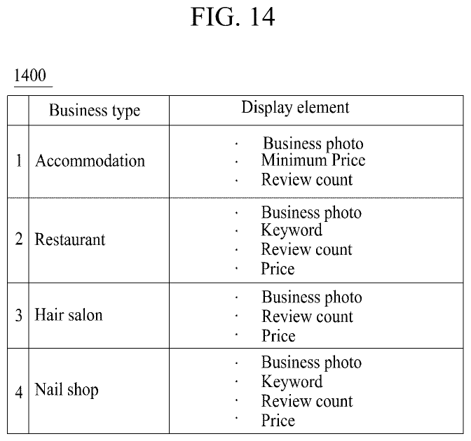

FIG. 14 illustrates a display element included in an advertising content item according to an advertising channel or the type of a product or service being sold through the advertising channel according to one example.

As shown in a table 1400 of FIG. 14, depending on an advertising channel or a business type of a product or service handled by the advertising channel, the type of a display element included in an advertising content item may be different. That is, depending on the advertising channel or the business type of the product or service handled by the advertising channel, the advertising content item may include a different display element to include an additional information item for more effective advertising.

Considering the example described with reference to FIGS. 13 and 14, an advertising content item (extended material) including shopping information may include, for example, a product image, price information, and a product name, whereas an advertising content item (extended material) including place information may include a place image, price information, a relevant keyword, and review information.

Also, the advertising content item including shopping information may be configured to display a plurality of advertising content items for top N (e.g., 8) products in search results using a search term or to display an advertising content item that describes a single product in more detail (including rating information) through a carousel UI.

The advertising content item including place information may include a different display element for each business type and may be configured to display a business photo+business information. The business photo may be uploaded by an advertiser and a predetermined number (e.g., 8) may be displayed. Depending on example embodiments, the advertising content item may be implemented to display only business information. The business information may include price information (e.g., minimum price), review information (review count, ratings), and a keyword. In an example embodiment, for example, when an advertisement for a specific location corresponding to an advertising channel is displayed in a Powerlink advertising area that is the advertisement display area 30, an advertising content item including business information acquired in conjunction with a vertical service (smart place service) associated with the specific location may be automatically displayed.

“Selection history information” described above with reference to FIGS. 1, 7, and 8 may be added and displayed in the advertising content item only for a logged-in user.

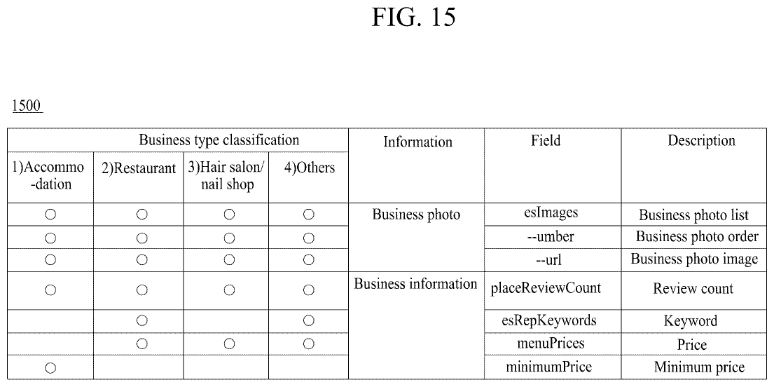

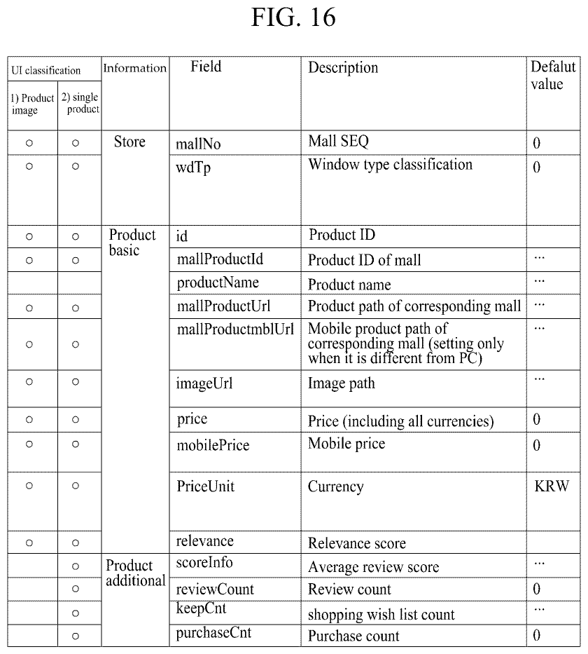

FIGS. 15 and 16 illustrate data extracted from search results to generate an advertising content item in conjunction with a vertical service search engine according to one example.

FIG. 16 illustrates information on fields used among search results from the vertical service search engine corresponding to a shopping service to generate an advertising content item that includes shopping information. Information included in the fields shown in a table of FIG. 16 may be used to generate the advertising content item of the example embodiment. Information including different fields depending on various conditions as reviewed above may be used to generate different advertising content items.

A table 1500 of FIG. 15 shows which field of information is used to generate an advertising content item by business type, including place information. As illustrated, advertising content items including different additional information items may be generated for the respective business types.

Therefore, in an example embodiment, an advertising content item including more suitable additional information may be generated according to a category or a business type of an advertising channel, which may lead to maximizing the advertising effect.

Description related to technical features made above with reference to FIGS. 1 to 12B may be applied to FIGS. 13 and 16, and repeated description is omitted.

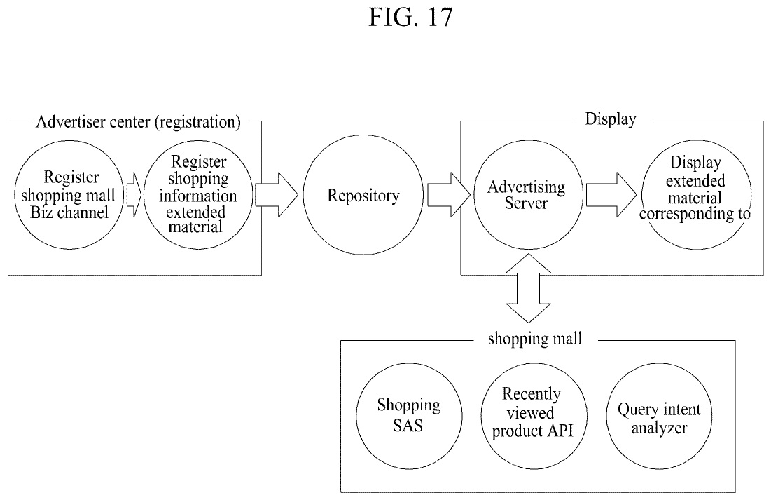

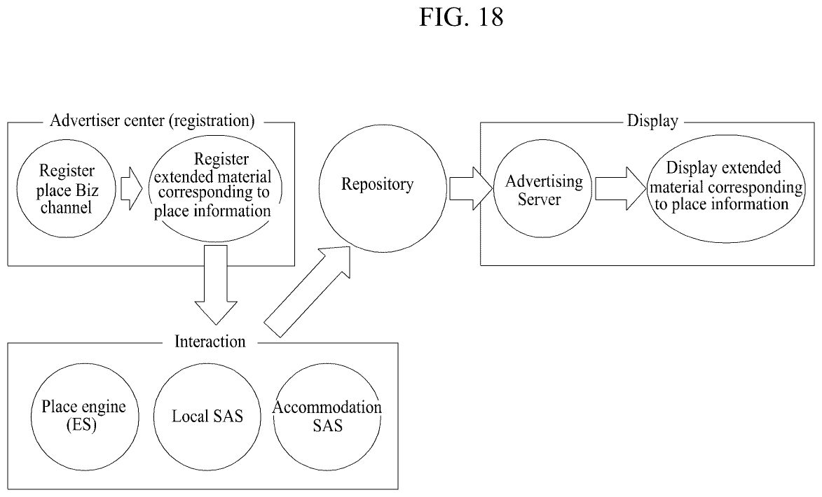

FIGS. 17 and 18 illustrate a method of determining an advertising content item for a product or service to be displayed in association with information on an advertising channel in response to a search request using a search term and displaying the determined advertising content item together with information on the advertising channel, in a relationship among an advertiser side, a vertical service search engine side, and an advertisement display side according to one example.

In FIG. 17, the operation from the perspective of generating an advertising content item that includes shopping information is described.

As illustrated, a Biz channel registration and an extended material registration for a shopping mall corresponding to an advertising channel may be performed in an advertiser center (platform), which may be stored in a repository (e.g., Dunkerque repository). In response to a search request using a search term, an advertising server may link with a vertical service search engine. That is, as illustrated, shopping SAS and the advertising server may be linked in real time in response to the search request. Here, the advertising server may make an inquiry for a recently viewed product API to acquire the aforementioned selection history information, and may interact with a query intent analyzer (e.g., Bifrost query intent analyzer) to determine the query intent of the search term. Therefore, in an example embodiment, determining an appropriate advertising content item and displaying the same on the user terminal 200 may be performed.

In FIG. 18, the operation from the perspective of generating an advertising content item that includes place information is described.

As illustrated, a Biz channel registration and an extended material registration for a specific location corresponding to an advertising channel may be performed in an advertiser center (platform), which may be stored in a repository (e.g., Dunkerque repository). However, when performing the extended material registration, interaction with the vertical service search engine may be performed. That is, as illustrated, the platform may interact with a place engine (elastic search (ES)), local SAS, and accommodation SAS. Data acquired through interaction may be stored in a repository (e.g., place table in repository). In response to a search request using a search term, an advertising server may determine an appropriate advertising content item using this stored information. Therefore, determining the advertising content item suitable for the search request from the user and displaying the same on the user terminal 200 may be performed.

That is, data of a field related to the extended material for place information in stored place data may be used to generate the advertising content item. Therefore, interaction with the vertical service search engine may not be performed in real time at the time of the search request.

Description related to technical features described above with reference to FIGS. 1 to 16 may also be applied to FIGS. 17 and 18, so repeated description is omitted.

The apparatuses described herein may be implemented using hardware components, software components, and/or the combination of the hardware components and the software components. For example, the apparatuses and the components described herein may be implemented using one or more computers or processing devices, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions executable through various computer methods. Here, the media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially designed to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

The foregoing description has been provided for purposes of illustration and description. It is not intended to be exhaustive or to limit the scope of the present invention. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the present invention.

What is claimed is:

1. A method of displaying an advertising content item associated with a search term, performed by a computer system that is a user terminal, the method comprising:
receiving a search term from a user; and
displaying, as search results for the search term on a search results page of the user terminer, information on an advertising channel associated with the search term and at least one advertising content item that links to a detailed information page for a product or service being sold through the advertising channel.

2. The method of claim 1, wherein the displaying comprises displaying, as the information on the advertising channel, a link of the advertising channel and the advertising content item in an advertisement display area within the search results page that provides the search results for the search term.

3. The method of claim 2, wherein the advertisement display area is provided at the upper end on the search results page, below a search term input field.

4. The method of claim 2, wherein the displaying comprises displaying a plurality of advertising content items that link to a detailed information page for each of products or services being sold through the advertising channel within a carousel user interface (UI) to be distinguished from information on the advertising channel, and
the carousel UI is configured to sequentially display at least some of the plurality of advertising content items without leaving the search results page, in response to a detection of an interaction from the user with the carousel UI.

5. The method of claim 1, wherein the advertising content item is configured to include at least two additional information items for the product or service being sold through the advertising channel such that different additional information items are included depending on a type of a vertical service associated with the advertising channel or a type of the product or service being sold through the advertising channel.

6. The method of claim 5, wherein the at least two additional information items include an image associated with the product or service being sold through the advertising channel, and at least one of price information on the product or service and review information on the product or service.

7. The method of claim 2, wherein the displaying comprises displaying the at least one advertising content item on the search results page, and displaying a fewer number of advertising content items as the width of the search results page, the width of the advertisement display area, or the width of the user terminal becomes smaller.

8. The method of claim 7, wherein as the fewer number of advertising content items are displayed on the search results page, the advertising content item is configured to include more additional information items for the product or service being sold through the advertising channel.

9. The method of claim 1, wherein the advertising content item includes an image associated with the product or service being sold through the advertising channel and selection history information on the product or service.

10. The method of claim 9, wherein the displaying comprises displaying an advertising content item including the selection history information on the search results page above other advertising content items for other products or other services being sold through the advertising channel.

11. The method of claim 1, wherein the advertising content item is displayed in a form in which an image and price information associated with the product or service being sold through the advertising channel are synthesized.

12. The method of claim 1, wherein the advertising channel is for advertising a service or product provided at a specific location, and
the method further comprises:
in response to a selection on the advertising content item from the user, displaying the detailed information page that includes detailed information on the product or service or a detailed information page of the advertising channel.

13. The method of claim 1, wherein the advertising channel is for advertising a service or product provided in a specific shopping mall, and
the method further comprises:
in response to a selection on the advertising content item from the user, displaying the detailed information page that includes detailed information on the service or product within the specific shopping mall.

14. A non-transitory computer-readable recording medium storing instructions that, when executed by a processor, cause the processor to execute the method of claim 1 on the computer system.

15. A computer system that is a user terminal for displaying an advertising content item associated with a search term, the computer system comprising:
at least one processor configured to execute computer-readable instructions included in a memory,
wherein the at least one processor is configured to receive a search term from a user, and to display, as search results for the search term, information on an advertising channel associated with the search term and at least one advertising content item that links to a detailed information page for a product or service being sold through the advertising channel.
